(19) United States
(12) Patent Application Publication
(10) Pub. No.: US 2018/0033210 A1
(43) Pub. Date: Feb. 1, 2018

(54) INTERACTIVE DISPLAY SYSTEM WITH SCREEN CUT-TO-SHAPE OF DISPLAYED OBJECT FOR REALISTIC VISUALIZATION AND USER INTERACTION

(71) Applicant: Nitin Vats, Meerut, Uttar Pradesh (IN)

(72) Inventor: Nitin Vats, Meerut, Uttar Pradesh (IN)

(21) Appl. No.: 15/127,010

(22) PCT Filed: Jan. 23, 2015
(86) PCT No.: PCT/IN2015/000042

§ 371 Date: Sep. 17, 2016

(30) Foreign Application Priority Data
Mar. 17, 2014 (IN) 3848/DEL/2013

(51) Int. Cl. G06T 19/20; G06F 3/0481

(52) U.S. Cl. CPC G06T 19/20; G06F 3/04815; G06F 3/04883

(57) ABSTRACT

A computer implemented method for visualization of a virtual model of an object over a cut-to-shape screen, wherein the screen dimensionally represents the virtual model of the object, such that an outer boundary of the virtual model either exactly aligned or nearly aligned to a boundary of the cut-to-shape screen, the method includes:
generating and displaying a first view of the virtual model onto the cut-to-shape screen, such that the outer boundary of the three dimensional model either exactly aligned or nearly aligned to the boundary of the cut-to-shape screen;
receiving an user input, the user input are one or more interaction commands, where each interaction command is provided for performing user-controlled interactions in real-time, wherein the interaction command is defined as input commands for performing different operations on different part/s of the virtual model to observe the virtual model and/or to experience functionality of virtual model and its part/s;
identifying one or more interaction commands;
in response to the identification, generating of corresponding interactive view of virtual model of object with or without sound output using texture data and computer graphics data of the virtual model of object with selective association of sound data and animation data;
displaying the generated corresponding interactive view of the virtual model either directly or via projector/s onto the cut-to-shape screen in response to the identification.

### FIELD OF INVENTION

The present invention relates to the field of computer graphics and virtual reality, particularly an interactive display system with screen cut-to-shape of displayed object for realistic visualization and user interaction with the displayed object.

### BACKGROUND OF THE INVENTION

Currently, life-size poster of an object is placed on an object cut-out hoarding such as a car cut-out hoarding. Here, realistic visualization and interaction with such hoardings or signage are lacking such as: users cannot see such objects such as car in different colors, or user themselves cannot interact with displayed object to change colors of displayed object; users cannot interact with displayed object to operate movable parts; see interior of the displayed object and operate internal parts. Further, in conventional systems or even in physical product displaying establishments, it is difficult to view functioning of different parts of the 3D object that are inaccessible such as car engine. Further, a typical brick and mortar establishment requires a lot of space in displaying different versions or models of a product, and not all variety are usually displayed due to space and/or cost constraint. There is often a time gap or delay between actual product launch date and availability in various physical establishments with one factor being time required for transportation.

Attempts have been made to virtually showcase products, especially a car on big electronic display screens in life-size with limited and pre-defined set of interactions available for users. In such conventional systems, objects are displayed on a rectangular screen which do not provide an illusion of reality like a real object placed in front of user.

Therefore, there a need to provide a system where real objects can be displayed providing an illusion of reality or illusion of real object placed before a user. Further, if user can do interaction with displayed object on such system such as to see object in different colors, see internal and external parts, perform natural interaction such as moving or sliding different parts of the displayed object, as user usually do with real object in real scenario, this will be great boon and a radical change for the advertisement industry, as currently advertisement industry still depends on putting hoarding or digital signage.

Therefore, there exists a further need to provide an interactive display system with screen cut-to-shape of displayed object on the screen, where displayed object is a realistic 3D computer model representing a real object, preferably in life-size providing an illusion of reality, where user-controlled interactions are possible with the displayed object in improved manner.

The object of the invention is to provide realistic visualization of virtual model over cut-to-shape screen.

### SUMMARY OF THE INVENTION

The object of invention is achieved by a method of claim 1, a computer program product of claim 32, and a system of claim 33.

According to one embodiment of the method, the steps involved are:
generating and displaying a first view of the virtual model onto the cut-to-shape screen, such that the outer boundary of the three dimensional model either exactly aligned or nearly aligned to the boundary of the cut-to-shape screen;
receiving an user input, the user input are one or more interaction commands, where each interaction command is provided for performing user-controlled interactions in real-time, wherein the interaction command is defined as input commands for performing different operations on different part/s of the virtual model to observe the virtual model and/or to experience functionality of virtual model and its part/s;
identifying one or more interaction commands;
in response to the identification, generating of corresponding interactive view of virtual model of object with or without sound output using texture data and computer graphics data of the virtual model of object with selective association of sound data and animation data;
displaying the generated corresponding interactive view of the virtual model either directly or via projector/s onto the cut-to-shape screen in response to the identification.

According to another embodiment of the method, wherein the cut-to-shape screen is either a screen illuminated by a projector/s receiving the interactive view by projecting the interactive view on the cut-to-shape screen or a self-illuminating screen receiving the interactive view and displaying the interactive view by illuminating itself.

According to yet another embodiment of the method, wherein the cut-to-shape screen is having a degree of transparency from complete transparency to complete opacity.

According to one embodiment of the method, wherein the virtual model is either two dimensional or three dimensional, and the computer graphics data is two dimensional computer graphics data of the object or three dimensional computer graphics data of the object.

According to another embodiment of the method, wherein the interactions includes extrusive interactions for interacting with exteriors of the virtual model of the object.

According to yet another embodiment of the method, wherein the virtual model includes a virtual electronic display corresponding to an electronic display of the object, such that the extrusive interaction comprises interacting with the virtual model for showing response of appropriate interaction in terms of change in graphics on the virtual electronic display and/or performing suitable operation in synchronization with part/s of the virtual model.

According to one embodiment of the method, wherein the extrusive interaction includes interacting with virtual model of object for tilting the virtual model of the object in different planes. The outer boundary of the virtual model after tilting either exactly aligned or nearly aligned to the boundary of the cut-to-shape screen.

According to another embodiment of the method, wherein the extrusive interaction includes operating the light-emitting parts of virtual model of object for functioning of the light emitting parts. The functioning of light emitting part is shown by a video as texture on surface of said light emitting part to represent lighting as dynamic texture change.

According to yet another embodiment of the method, wherein the extrusive interaction includes interacting with virtual model for producing sound effects.

According to one embodiment of the method, wherein the extrusive interaction includes interactions for color/texture change of the virtual model of the displayed object.

According to another embodiment of the method, wherein the extrusive interaction comprises interactions for operating and/or removing the movable parts of the virtual model of the object, wherein operating the movable parts comprises sliding, turning, angularly moving, opening, closing, folding, and inflating-deflating the parts.

According to yet another embodiment of the method, wherein the interactions includes intrusive interactions for interacting with internal parts and/or sub-parts of the virtual model. The sub-parts are those parts of the 3D-model which are moved and/or slided and/or rotated and/or operated for using the object, and the internal parts of the 3D-model represent parts of the object which are responsible for working of object but not required to be interacted for using the object. The interacting with internal parts includes removing and/or disintegrating and/or operating and/or rotating of the internal parts.

According to one embodiment of the method, wherein the intrusive interactions includes engineering disintegration interaction with part of the virtual model for visualizing the part within boundary of the cut-to-screen, the part is available for visualization only by dismantling the part from the entire object.

According to another embodiment of the method, wherein the intrusive interactions includes creating transparency-opacity effect for converting the internal part to be viewed as opaque and remaining virtual model as transparent or nearly transparent.

According to yet another embodiment of the method, wherein interacting with the opaque part for rotating the opaque part in any plane around 360 degree and/or moving the opaque part within the boundary of the cu-to-shape screen and/or disintegrating the opaque part, and/or operating and/or customization of the opaque part.

According to one embodiment of the method, wherein the interaction includes time bound change based interactions, such that the time bound change is shown by dynamic change in the color and/or texture of surface of the virtual model. Different color and/or texture refers to different values of the physical property. The time bound changes refers to representation of changes in the virtual model demonstrating change in physical property of object in a span of time on using or operating of the object.

According to another embodiment, wherein the interaction includes physical property based interactions to a surface of the virtual model, such that response to physical property based interactions are shown by change in color and/or texture of the surface of the virtual model. Different color and/or texture refer to different values of the physical property. Physical property based interactions are made to assess a physical property of the surface of the virtual model.

According to one embodiment of the method, wherein the physical property includes softness, hardness, pressure and temperature.

According to another embodiment of the method, wherein the interaction includes real environment mapping based interaction, which includes capturing an area in vicinity of the user, mapping and simulating the video/image of area of vicinity on a surface of the virtual model.

According to another embodiment of the method, wherein the interactions comprises addition based interaction for attaching or adding a part to the virtual model, and/or deletion based interaction for removing a part of virtual mode.

According to one embodiment of the method, wherein the interaction includes interactions for replacing the part of the virtual model with another part with same or different texture and/or shape and/or size by changing texture as well as graphics data of the part, such that that the outer boundary of the virtual model after customization is either exactly aligned or nearly aligned to the boundary of the cut-to-shape screen.

According to another embodiment of the method, wherein the replaced part is adapted to be interacted.

According to yet another embodiment of the method, wherein the interaction includes demonstration based interactions for requesting demonstration of operation of the part/s of the object which are operated in an ordered manner to perform a particular operation, response to such interaction includes automatic ordered operation of demonstrating part/s, whereas other part/s of virtual object are available for user controlled interactions while such operation is being performed automatically.

According to one embodiment of the method, wherein the interaction includes linked-part based interaction, such that when an interaction command is received for operating one part of virtual model, than in response another part linked to the operating part is shown operating in the virtual model along with the part for which the interaction command was received.

According to another embodiment of the method, wherein the interaction includes liquid and fumes flow based interaction for visualizing liquid and fumes flow in the virtual model.

According to yet another embodiment of the method, wherein the interaction comprises immersive interactions, the immersive interactions are defined as interactions where users visualize their own body performing user-controlled interactions with the virtual model.

According to one embodiment of the method, wherein the displayed virtual model of the object is a computer graphics model textured using real photographs and/or video.

According to another embodiment of the method, wherein the displayed virtual model of object is a computer graphics model textured using colour texture, images, preferably photographs and/or video, or their combination.

According to yet another embodiment of the method, wherein displayed external and/or internal surfaces of the virtual model in-or-during each interactions are textured using photographs and/or video, where the display of texture on the virtual model surfaces using photographs ranges from 10-100% of total surfaces, which corresponds to non-mono-colour surface and surfaces which show pattern or non-uniform texture on the real object.

According to one embodiment of the method, wherein if the displayed virtual model comprises a surface, which corresponds to functioning part in the real object, then a video is usable as texture on said surface of the virtual model during interaction to represent dynamic texture change on said surface.

According to one embodiment of the system, the system includes the cut-to-shape screen which is self illuminating or illuminated through projector/s dimensionally represents the virtual model of the object, such that an outer boundary of the virtual model either exactly aligned or nearly aligned to a boundary of the cut-to-shape screen. The system also includes a computer graphics data related to graphics of the virtual model of the object, a texture data related to texture of the virtual model, and/or an audio data related to audio production by the virtual model, and/or an animation data related to animations of the virtual model, which is stored in one or more memory units. The system also includes machine-readable instructions that upon execution by one or more processors cause the system to carry out operations as per the method steps of claim 1.

According to another embodiment of system, wherein at least one of the processors and/or at least one of the memory units are remotely placed and connected to the other processors and other memory units over a communication network.

According to yet another embodiment of system, the system further includes one or more sound output devices for providing synchronized sound output during display of the interactive view of the virtual model.

According to one embodiment of system, wherein the input device includes at least one of a touch screen, a sensor unit configured for receiving gesture input commands for performing user-controlled interactions, a touch sensitive electronic display, a voice input device, a pointing device, a keyboard or presence-sensitive panel, computer mouse, joystick, microphone, still camera and/or video camera, tactile based input device or combination thereof.

According to another embodiment of system, wherein the memory unit/s further includes a set of system libraries used by the processor for generating response to the interaction command, the system libraries comprises functionalities for:
producing sound as per user-controlled interaction;
animation of one or more parts in the 3D model;
providing functionality of operation of electronic or digital parts in the displayed 3D-model/s depending on the characteristics, state and nature of displayed object;
decision making and prioritizing user-controlled interactions response;
putting more than one 3D object/model in scene;
generating surrounding or terrain around the 3D model;
generating effect of dynamic lighting on the 3D model;
providing visual effects of colour shades; and
generating real-time simulation effect;
using one or more environmental condition data comprising temperature, moisture, time or geographical/location related information.

According to yet another embodiment of system, the system includes multiple cut-to-shape screen, wherein the multiple cut-to-shape screens are displaying synchronized output in response of user input from at least one user input device, such that at least one of the cut-to-shape screen is adapted to display the virtual model.

According to one embodiment of system, the system includes at least one display screen other than cut-to-shape screens, wherein the display screen is adapted to display video including a video of virtual assistant with/without synchronization of output shown on cut-to-shape screen.

According to another embodiment of system, the system includes at least one cut-to-shape screen which shows a video of virtual assistant with/without synchronization of virtual model shown on other cut-to-shape screen.

According to one embodiment of a cut-to-shape screen for displaying a virtual model of an object, wherein the screen dimensionally represents the virtual model of the object, such that an outer boundary of the virtual model either exactly aligned or nearly aligned to a boundary of the cut-to-shape screen, the screen is adapted to:
display a first view of the virtual model onto the cut-to-shape screen, such that the outer boundary of the virtual model either exactly aligned or nearly aligned to the boundary of the cut-to-shape screen;
display an interactive view of the virtual model synchronized with sound output onto the cut-to-shape screen in response to an user input received for one or more interaction commands for performing interactions in real-time and identification of each of the interaction commands,
wherein for displaying the interactive view of the virtual model either directly or via projector/s onto the cut-to-shape screen, the interaction commands are identified and based on the identification, the interactive view of the virtual model of the object is generated and/or rendered, wherein the interactive view is generated using texture data and computer graphics data of the virtual model of object with selective association of sound data and animation data.

According to another embodiment of cut-to-shape screen, wherein the cut-to-shape screen is having a degree of transparency from complete transparency to complete opacity.

### BRIEF DESCRIPTION OF THE DRAWINGS

The invention and many advantages of the present invention will be apparent to those skilled in the art with a reading of this description taken in conjunction with the accompanying drawings, in which like reference numerals identify like elements, and in which:

FIG. 1 shows a block diagram of a client device for visualizing a virtual model onto a cut-to-shape screen.

FIGS. 2 (a)-(d) shows a schematic view of an example interactive display system with a cut-to-shape display screen dimensionally representing a real mobile, and also showing some interaction with virtual model being displayed onto the cut-to-shape screen according to an embodiment of the present invention.

FIGS. 3 (a)-(c) illustrates an example for color change interaction with the virtual model.

FIGS. 4 (a)-(c) illustrate an example interaction of operating movable external parts and un-interrupted view of interior or accessible internal parts of the virtual model of the object.

FIGS. 5(a)-(c), illustrates an example interaction of operating movable internal parts of virtual model and interaction of transparency-opacity effect for viewing internal parts distinctly.

FIGS. 6(a)-(b) illustrates an example interaction of un-interrupted view of inaccessible internal parts using transparency-opacity effect for understanding functioning of the inaccessible internal parts.

FIG. 7 illustrates an example interaction of vertical and horizontal tilt with the virtual model.

FIGS. 8(a)-(b) illustrates folding motion interaction as an example of operating movable external parts.

FIG. 9 shows an example interaction of replacing parts of the virtual model with corresponding new parts having different texture.

FIGS. 10 (a)-(e) illustrates an example of interactively replacing part/s of a virtual model.

FIGS. 11 (a)-(e) illustrates an example of demonstration based interactions onto part/s of a virtual model.

FIG. 12 illustrates a schematic of network connections, which implements the system for visualizing a virtual model onto a cut-to-shape screen.

FIGS. 13(a)-(c) illustrates an exemplary system for visualizing at least virtual model onto a cut-to-shape screen.

FIGS. 14(a)-(b) illustrates block diagrams of embodiments having two different types of cut-to-shape screens.

While the invention is susceptible to various modifications and alternative forms, specific embodiments thereof have been shown by way of example in the drawings and are herein described in detail.

### DETAILED DESCRIPTION

Illustrative embodiments of the invention are described below.

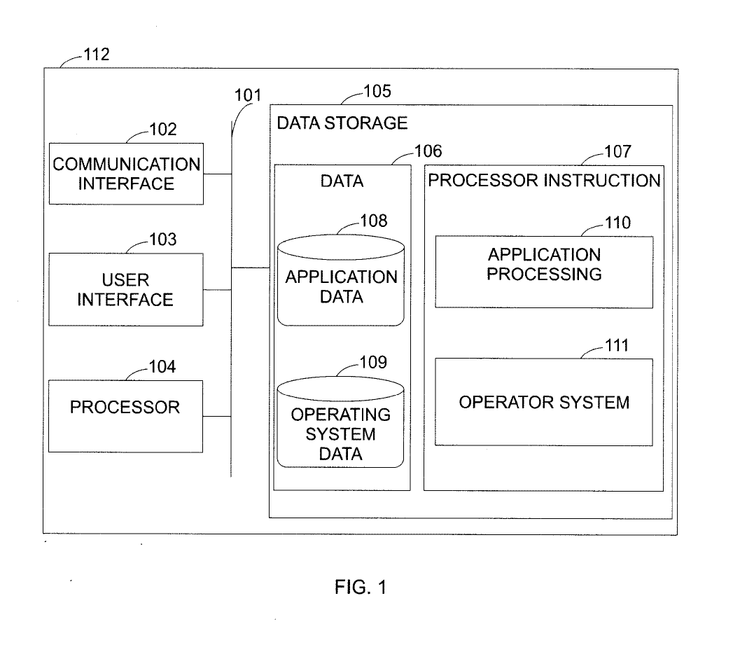

FIG. 1 is a simplified block diagram showing some of the components of an example client device 112. By way of example and without limitation, client device is a computer equipped with one or more wireless or wired communication interfaces.

As shown in FIG. 1, client device 112 may include a communication interface 102, a user interface 103, a processor 104, and data storage 108, all of which may be communicatively linked together by a system bus, network, or other connection mechanism 101.

Communication interface 102 functions to allow client device 112 to communicate with other devices, access networks, and/or transport networks. Thus, communication interface 102 may facilitate circuit-switched and/or packet-switched communication, such as POTS communication and/or IP or other packetized communication. For instance, communication interface 102 may include a chipset and antenna arranged for wireless communication with a radio access network or an access point. Also, communication interface 102 may take the form of a wireline interface, such as an Ethernet, Token Ring, or USB port. Communication interface 102 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 102 Furthermore, communication interface 102 may comprise multiple physical communication interfaces (e.g., a Wifi interface, a BLUETOOTH® interface, and a wide-area wireless interface).

User interface 103 may function to allow client device 112 to interact with a human or non-human user, such as to receive input from a user and to provide output to the user. Thus, user interface 103 may include input components such as a keypad, keyboard, touch-sensitive or presence-sensitive panel, computer mouse, joystick, microphone, still camera and/or video camera, gesture sensor, tactile based input device. User interface 103 may also include one or more output components such as a cut to shape display screen illuminating by projector or by itself for displaying objects, cut to shape display screen illuminating by projector or by itself for displaying virtual assistant.

User interface 103 may also be configured to generate audible output(s), via a speaker, speaker jack, audio output port, audio output device, earphones, and/or other similar devices, now known or later developed. In some embodiments, user interface 103 may include software, circuitry, or another form of logic that can transmit data to and/or receive data from external user input/output devices. Additionally or alternatively, client device 112 may support remote access from another device, via communication interface 102 or via another physical interface.

Processor 104 may comprise one or more general-purpose processors (e.g., microprocessors) and/or one or more special purpose processors (e.g., DSPs, CPUs, FPUs, network processors, or ASICs).

Data storage 105 may include one or more volatile and/or non-volatile storage components, such as magnetic, optical, flash, or organic storage, and may be integrated in whole or in part with processor 104. Data storage 105 may include removable and/or non-removable components.

In general, processor 104 may be capable of executing program instructions 107 (e.g., compiled or non-compiled program logic and/or machine code) stored in data storage 105 to carry out the various functions described herein. Therefore, data storage 105 may—include a non-transitory computer-readable medium, having stored thereon program instructions that, upon execution by client device 112, cause client device 112 to carry out any of the methods, processes, or functions disclosed in this specification and/or the accompanying drawings. The execution of program instructions 107 by processor 104 may result in processor 104 using data 106.

By way of example, program instructions 107 may include an operating system 111 (e.g., an operating system kernel, device driver(s), and/or other modules) and one or more application programs 110 installed on client device 112 Similarly, data 106 may include operating system data 109 and application data 108. Operating system data 109 may be accessible primarily to operating system 111, and application data 108 may be accessible primarily to one or more of application programs 110. Application data 108 may be arranged in a file system that is visible to or hidden from a user of client device 112.

Application Data 108 includes virtual model data that includes two-dimensional and/or three dimensional graphics data, texture data that includes photographs, video, color or images, and/or audio data, and/or virtual assistant data that include video and audio.

Application Programs 110 includes programs for performing the following steps, when executed over the processor:
rendering and displaying a first view of the virtual model onto the cut-to-shape screen, such that the outer boundary of the virtual model either exactly aligned or nearly aligned to the boundary of the cut-to-shape screen,
receiving an user input, the user input are one or more interaction commands, where each interaction command is provided for performing user-controlled interactions in real-time, wherein the interaction command is defined as input commands for performing different operations on different part/s of the virtual model to observe the virtual model and/or to experience functionality of virtual model and its part/s, identifying one or more interaction commands,
in response to the identification, rendering of corresponding interactive view of virtual model of object with synchronized sound output using texture data and computer graphics data of the virtual model of object with selective association of sound data, and
displaying the generated corresponding interactive view of the virtual model either directly or via projector/s onto the cut-to-shape screen in response to the identification.

Application program 110 further includes a set of system libraries which includes a sound engine for producing sound as per user interaction, a motion library responsible for animation data of virtual model motion of one or more parts. The virtual operating sub-system for providing functionality of operation of electronic or digital parts in the displayed virtual model depending on the characteristics, state and nature of displayed object. It stores the functionality of GUI look and output for different input via virtual model part/s or GUI itself or other kind of inputs and also make response for different input of GUI to make a response for part/parts of virtual model or other GUI based output. an Artificial Intelligence (AI) engine for decision making and prioritizing user-controlled interactions response, a scene graph for primarily for putting more than one virtual model in scene, lighting and shadow for generating the effect of light of virtual model, a shader for providing visual effects such as colour shades, and a physics/simulation engine for generating simulation effect, for example for showing the functioning of folding the roof of car, to show wrinkles in folding material, libraries comprises functionalities for generating real-time simulation effect, rendering unit, library, and control unit/logic for generating different kind of interactions as per input using rendering engine and database & selective use of system libraries.

According to another embodiment, during mirror effect and immersive interactions, the Application program 110 uses live video input from camera, which is directly passed to message handler. The message handler further transmits the input or interaction command to the control unit of the application program 110.

Initially, user input can generate a network message, an operating system message, or is direct input. The network message means a command or event generated by the user input which is sent by server software to client software in same machine or any host connected through network for an action by the client. The operating system message is a command or event generated by user input by a device handler to the client software via operating system inter process communication/message queue/ or an action by the client device. In the direct input or direct messaging, the device handler and the client software are a single application, hence commands or event are directly bound to the device handler. A message Interpreter interprets the message (command/event) based upon the context and calls the appropriate handler for an action. Message handler, or event handler are logic blocks associated with an action for controls. User input can be provided using infrared based sensor, voice command based sensor, camera based sensor, or touch based screens.

As described above, an interactive, graphical user interface that functions to display a virtual object on a cut to shape screen through projector or self illuminating cut to shape screen with or without virtual assistant displayed through projector or self illuminating cut to shape screen connected to client display device, while providing a capability to interactively operate the virtual object through a variety of interactions:
interactions for colour change of displayed virtual model,
operating movable external parts of the virtual model,
operating movable internal parts of the virtual model,
interaction for getting un-interrupted view of interior or accessible internal parts of the virtual model,
transparency-opacity effect for viewing internal parts and different parts that are inaccessible,
replacing parts of displayed object with corresponding new parts having different texture,
interacting with displayed object having electronic display parts for understanding electronic display,
operating system functioning, vertical tilt interaction and/or horizontal tilt interaction,
operating the light-emitting parts of virtual model of object for functioning of the light emitting parts,
interacting with virtual model for producing sound effects,
engineering disintegration interaction with part of the virtual model for visualizing the part within boundary of the cut-to-screen, the part is available for visualization only by dismantling the part from the entire object,
time bound change based interactions to represent of changes in the virtual model demonstrating change in physical property of object in a span of time on using or operating of the object,
physical property based interactions to a surface of the virtual model, wherein physical property based interactions are made to assess a physical property of the surface of the virtual model
real environment mapping based interaction, which includes capturing an area in vicinity of the user, mapping and simulating the video/image of area of vicinity on a surface of the virtual model
addition based interaction for attaching or adding a part to the virtual model,
deletion based interaction for removing a part of virtual model,
interactions for replacing the part of the virtual model,
demonstration based interactions for requesting demonstration of operation of the part/s of the object which are operated in an ordered manner to perform a particular operation,
linked-part based interaction, such that when an interaction command is received for operating one part of virtual model, than in response another part linked to the operating part is shown operating in the virtual model along with the part for which the interaction command was received,
liquid and fumes flow based interaction for visualizing liquid and fumes flow in the virtual model with real-like texture in real-time
immersive interactions, where users visualize their own body performing user-controlled interactions with the virtual computer model.

The displayed virtual model is preferably a life-size or greater than life-size representation of real object.

Cut to shape display is required to display virtual models of objects and/or virtual assistant. Such screen can be fabricated by OLED, AMOLED, which is self-illuminating by passing current. Cut to shape screen may be made up of film that can be adhered to acrylic or glass cut to shape sheet or may be made by sandwiching the film between support sheets and projector can illuminate the cut-to-shape display.

The films are thin sheets of plastic applied to the support. A cut to shape film is a two-dimensional display technology using formed microlenses that bundles light. This film can be opaque or transparent. It is possible to work with different degrees of opacity that can vary between 90% and 98%, depending on the application (interior, exterior, natural lighting, artificial lighting, etc.)

The projector generates the beams of light that will form the image on the screen's film, which is adhered to the cut to shape support made of acrylic or glass.

Cut-to-shape support of the virtual object can be made by cutting acrylic by laser or router on a flat bed-cutting machine. Thereafter film can be applied to the backside of the acrylic and corners of the film can be trimmed by knife. Such Film provides high contrast, high resolution displays with ultra-wide viewing angles in all lighting conditions with the capability to cut the film to any size and shape.

The projector is usually located behind the screen and must be placed a certain angle above or below the user's line of sight to avoid the dazzling the user.

The beam manipulation by the lenses can be used to make the image appear to be floating in front of or behind the glass, rather than directly on it. However, this display is only two-dimensional and not true three-dimensional.

Another kind of film along with above mentioned screen film may be adhered with support to make cut to shape screen touch sensitive. Tactile membrane film is a thin film, which enables interactivity. Capacitive projected technology catches user input and sends impulses to the computer.

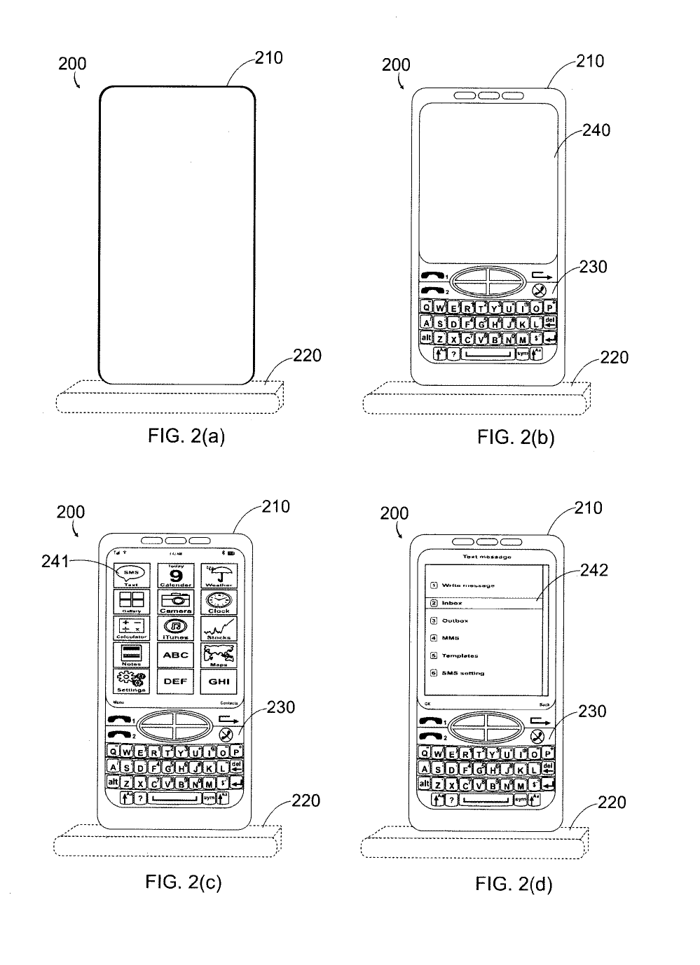

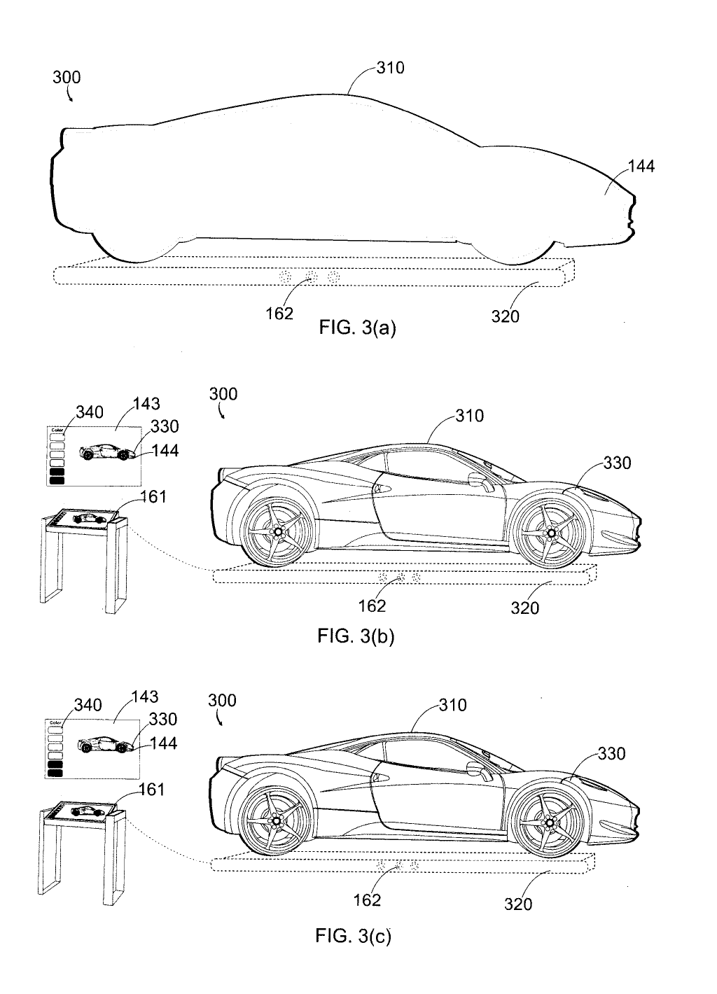

The cut-to-shape display screen is cut-to-shape of the displayed virtual model such that outer boundaries of the displayed virtual model coincides or nearly coincides with the boundaries of the cut-to-shape display screen providing pleasing and aesthetic view of the displayed virtual model representing real object/product. The cut-to-shape display screen can be of variable size and shape depending on the shape and size of the real object of which digital representation is to be displayed on the cut-to-shape display screen, as shown by way of example in illustration of FIG. 2(a) and illustration of FIG. 3(a), each representing a real mobile and real car respectively.

According to another embodiment, the displayed virtual model of the object is a computer graphics model, which is textured using
real photographs and/or video, or
colour texture, images, preferably photographs and/or video, or their combination.

Displayed external and/or internal surfaces of the virtual model in-or-during each interactions are textured using photographs and/or video, where the display of texture on the virtual model surfaces using photographs ranges from 10-100% of total surfaces, which corresponds to non-mono-colour surface and surfaces which show pattern or non-uniform texture on the real object.

According to another embodiment, the virtual model is textured using, textures obtained from photographs, use of video file as texture, color or images. Texture data include texture for virtual model and its functioning surfaces such as for showing the function of digital/electronic part. Virtual model can be textured using computer generated colors, brightness, hue, shades as well. It may be added in virtual model generation environment or during the rendering by using libraries for color, shades or other properties which are associated with rendering engine. For providing realistic look texture may be prepared from real photographs, images, videos. Video is used as texture in the virtual model only for that surface/s which corresponds to functioning part such as light-emitting parts in the real object. The use of video enhances reality in displaying dynamic texture changes for function part for lighting effect (one of extrusive and intrusive interactions). Multiple textures pre-calibrated on virtual model UV layouts can be stored as texture data for one/same surface in the database, which are called for or fetched dynamically by the Application Programs 110 during the user-controlled interactions.

According to another embodiment for the texturing of a three-dimensional virtual model of an object using photograph and/or video, the method comprising:

using plurality of photographs and/or video of the real object and/or the real object's variants, where said photographs and/or video are used as texture data;
(a). selecting one or more surfaces of one or more external and/or internal parts of the 3D model;
(b). carrying out UV unwrap of selected surface/s of the 3D model for generating UV layout for each selected surface;
(c). identifying texture data corresponding to each UV layout, and applying one or more identified photographs and/or video as texture data on each corresponding UV layout, while performing first calibration for photographs and/or first calibration for video;
(d). after first calibration and for the selected surface/s, joining or adjacently placing all UVs of related UV layouts comprising first calibrated texture to form texture for the selected surface/s, while performing second calibration; and
(e). repeating steps (a) to (d) until all chosen external and/or internal surfaces of the virtual model are textured using photographs and/or video, while at the joining of surfaces of different set of the selection of surfaces, applying third calibration for making seamless texture during each repetition step,
wherein the calibrated textures and corresponding virtual-model is stored as texture data and virtual model data respectively for use in user-controlled interactions implementation,
wherein video is used as a texture in the virtual model for surfaces corresponding to functioning parts in real object, and for surfaces whose texture changes dynamically during operation of said functioning parts, and
wherein at least one of the above steps is performed on a computer.

If the displayed virtual model includes a surface, which corresponds to functioning part in the real object, then a video is usable as texture on said surface of the virtual model during interaction to represent dynamic texture change on said surface.

The outer boundary of the virtual model is always aligned to the boundary of the cut-to-shape display screen during interactions. The alignment of outer boundary of the virtual model is either coincides to the boundary of the cut-to-shape display screen or a gap may be present between the boundaries to allow vertical and/or horizontal tilt interaction.

Embodiments of the present invention may be implemented using any suitable apparatus. Such an apparatus may include, but is not limited, to data processing machines and devices, for example computers or server computers.

Throughout the description, “virtual model” and “displayed object” shall be interchangeably used.

According to another embodiment, The virtual product assistant sub-system includes:

Instructions stored in a non-transitory computer readable storage system executable by the one or more processors that upon such execution cause the one or more processors to perform operations comprising:
receiving a user input, the input is in the form of at least one natural language speech such as in English language provided using a hardware voice input device that is in communication with the virtual product assistant sub-system, where the user voice input is either a product information query for gaining product information in real-time or an introduction related speech for introduction and salutation;
processing voice-based input to retrieve relevant information as per received product information query or introduction related speech;
outputting reply in the form of natural language speech with lip-synchronization of spoken words displayed in graphics accordance to the current virtual model display state displayed on the electronic panel system, wherein the lip-synchronization occurs dynamically in image or video of displayed virtual product assistant, using one or more processors, by an image processor. During outputting reply in the form of natural language speech, the output speech is customizable for pronunciation, masculine and feminine voice using a sound engine. The processing voice-based input to retrieve relevant information further comprises:
performing speech recognition using voice recognition engine to transcribe spoken phrase or sentence into text acceptable by said virtual assistant sub-system;
ascertaining meaning of the text to differentiate between introduction query and product information query using a Natural Language Processing (NLP) engine, to aid in matching of input with corresponding product information data set;
if input is a product information query, matching the input with active product information data set relevant to the product displayed on cut to shape display;
if input is introduction related query, matching the input with introduction related query data set relevant to the introduction query.

The output is as per the query with synchronized graphics. The voice input from a microphone is transmitted to the message handler and then passes to the virtual product assistant unit.

For example, a user may ask following queries using the microphone/text when a virtual model of bike of a particular model, say model X is displayed on the cut to shape display and receive corresponding repliesfrom the virtual product assistant:

Query-1: What is the mileage of this bike?
Reply-1: Mileage of this bike is 65 km per liter of petrol.
Query-2: What is the special feature about this bike?
Reply-2: It has an excellent suspension system and a sports bike-like looks.
Query-3: In how many variants is it available?
Reply-3: There are two variants and 6 colors available for each variant.

Virtual assistant may be made up of using 3d graphics data, texture data, rigging & morphing/animation data to generate expression/movement. It may be made of 2D graphics and expression/movement is generated by image processing also it may be made of multiple pre recorded/rendered video clips.

Now referring to FIG. 2(a), an interactive display system 200 with a cut-to-shape display screen 210 cut-to-shape of virtual model 230 representing a real mobile, and also showing some interaction with the displayed object. A base 220 is provided to support the cut-to-shape screen. The base 220 can be of any size and shape depending on the virtual model to be displayed.

In FIG. 2(b), an object 230 representing a real mobile is displayed in a first view. The first view is displayed according to pre-set conditions, whereas all consequent views are rendered in real-time in user interactions as per user provided interaction commands.

FIG. 2(c) illustrates user-controlled interaction of interacting with the virtual model 230 having electronic display part 240 for understanding electronic display and operating system functioning. A user provides an interaction command to operate movable external parts such as pressing a mobile key of the virtual model 230 displayed on the cut-to-shape display screen 210, which displays in real-time a corresponding interactive view of the virtual model 230 in power-on mode. A further input in the form of interaction command to press a menu key of the virtual model 230 appearing in the cut-to-shape display screen 210 to display a corresponding Menu layout, emulating a real interaction with a physical mobile. The user can continue to interact with the displayed corresponding interactive view from last performed interaction. A further input to select a messaging icon 241 by pressing a mobile key on displayed object 230, displays in real-time a corresponding messaging window 242 as shown in FIG. 2(d).

FIGS. 3(a)-(c) illustrates an example interactive display system with color change interaction with the displayed object. FIG. 3(a) illustrates an interactive display system 300 with a cut-to-shape display screen 310 cut-to-shape of displayed object 330 representing a real car, a sensor unit 162 for receiving gesture input, and a base 320 for fixing the cut-to-shape display screen 310. In some implementation, the cut-to-shape display screen 310 can be hanged from ceiling using straps or hanged in wall, and in such implementation, the use of base 320 is optional.

In FIG. 3(b), the interactive display system 300 is shown integrated with both the touch pad 143 for touch input, and sensor unit 162 for gesture input. The display environment displaying first view of object, that is virtual model 330, 144 representing real car is synchronized in both touch pad and the cut-to-shape display screen 310. A user can provide a touch input on the GUI selecting a color option in color menu 340 to change the color of the displayed virtual model 330, 144 from original to the chosen colour as shown in illustration of FIG. 3(c). The user can also provide interaction command of color change using gesture input optionally. In color change interactions, color of the displayed object can be changed to another color as per user choice.

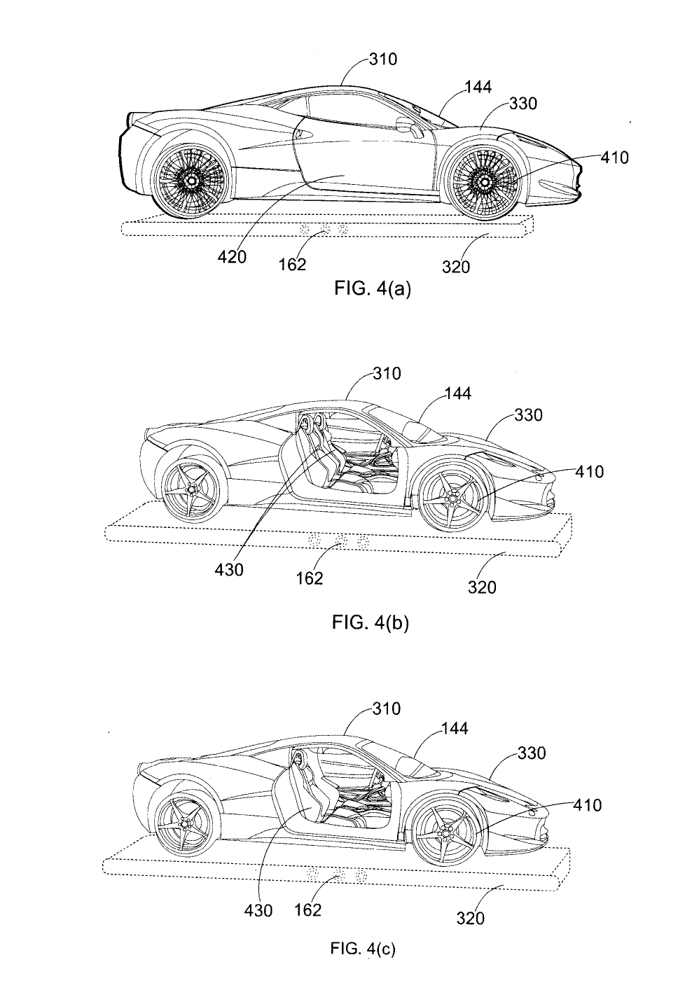

FIGS. 4(a)-(c) shows an example interaction of operating movable external parts and un-interrupted view of interior or accessible internal parts of displayed object.

FIG. 4(a) illustrates interaction of operating movable external parts. This type of interactions involves moving or operating a part of the displayed object viewed from exterior side that can be moved in reality in physical object. For example, moving car wheel 410 in its axis of rotation as shown in illustration of FIG. 4(a). Other examples can be door opening and closing interaction, pressing keys, sliding movement such as fuel tank door sliding, pulling interaction or folding motion interaction, rotating motion interaction and turning motion.

FIGS. 4(a)-(c) illustrates interaction for un-interrupted view of interior or accessible internal parts of displayed object 144 by deleting or removing parts of displayed object 144. A user can provide deletion interaction command to delete parts such as a car door part 420 as shown in illustration FIG. 4(a), which is deleted in user-controlled interaction as shown in FIG. 4(b) to get un-interrupted view of interior of virtual model representing real car. The user can further remove another part such as removing a seat part 430, as shown in of FIG. 4(c), where one of the two front seats is shown removed by user in an interaction.

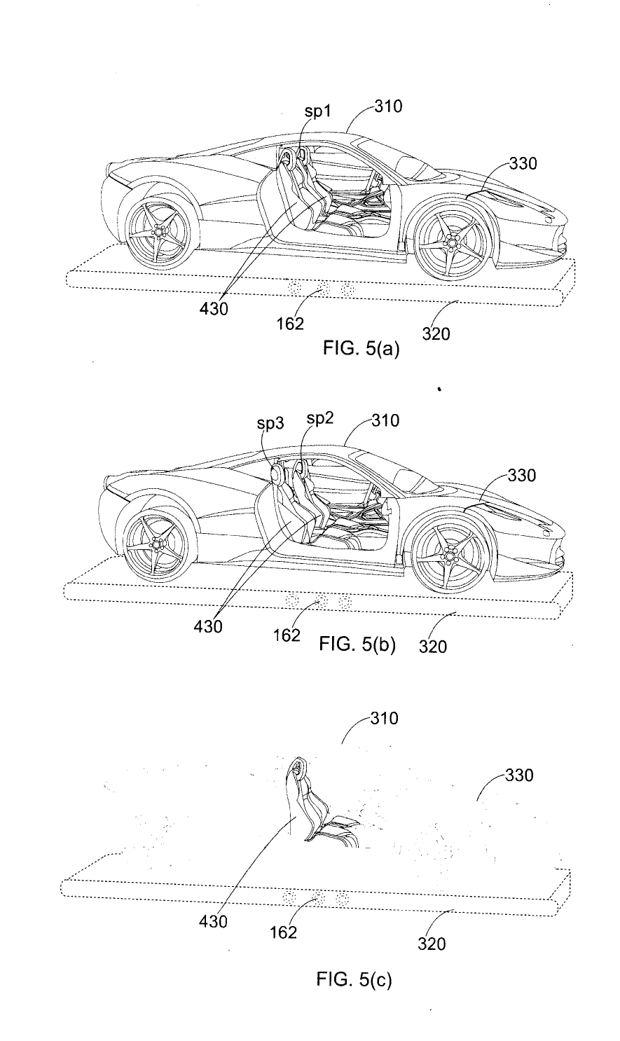

FIGS. 5(a)-(c), an example interaction of operating movable internal parts such movement of the seat part 430 of displayed object in a further interaction with the object displayed in illustration of FIG. 4(b) in the interactive display system. The interaction of operating movable internal part, involves moving a sub-part of the object displayed in interior view and/or moving a sub-part housed inside the displayed object, emulating real movement as in reality in physical object. One of the car seat part 430 is moved from position sp1 shown in illustration of FIG. 5(a) to position sp2 as shown in illustration of FIG. 5(b) in an user-controlled interaction as per user choice in real-time. In a further interaction one of the car seat part 430 is moved from position sp3 shown FIG. 5(c) to position sp4 as shown in FIG. 5(d) in an user-controlled interaction as per user choice in real-time. Further, the user can use Transparency-opacity effect interaction option, where certain part/s of the displayed object is opaque, while rest of the sub-parts is displayed as transparent. This effect makes possible viewing interior sub-parts in its precise location clearly in an un-interrupted view. For example, viewing car seat in a transparency-opacity effect as shown in FIG. 5(c), where except the car seat part 430, all other parts of the displayed virtual model are made transparent. An interaction can be performed in combination or in further continuation of another interaction. For example, interaction of operating movable internal parts or external parts can be done in- or during-transparency-opacity effect.

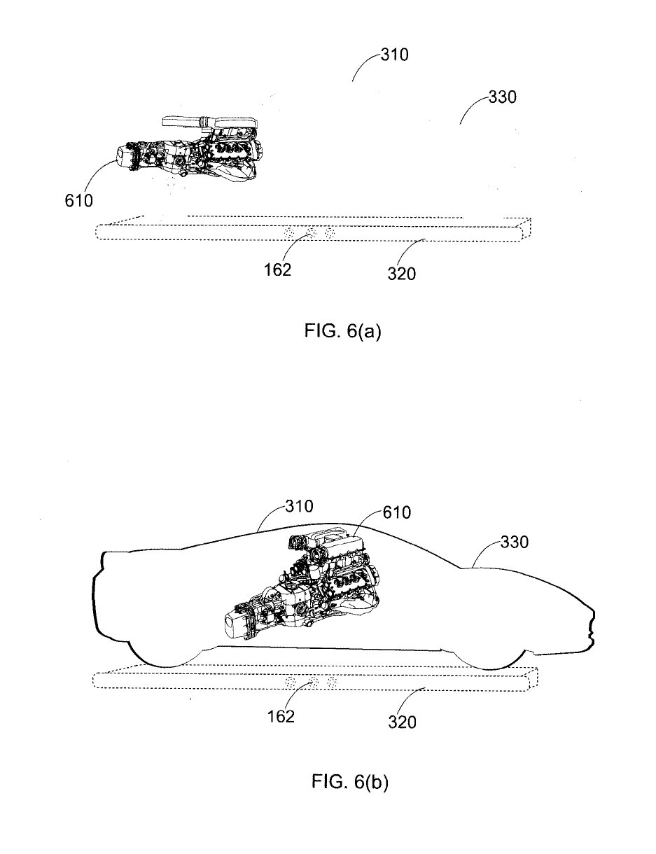

FIGS. 6(a)-(b) illustrates an example interaction of getting un-interrupted view of inaccessible internal parts using transparency-opacity effect for understanding functioning of the inaccessible internal parts of displayed object.

Some parts of the object are inaccessible from exterior and interior view, and may remain hidden under other parts unless and until all the parts covering or blocking the view of the hidden part are removed and dismantled. For example, a car engine may remain hidden housing and other parts fitted over the engine part. Such hidden parts can also be viewed in an interaction of getting un-interrupted view of inaccessible internal parts using transparency-opacity effect, such as viewing otherwise inaccessible a car engine part 610 in its original position as shown in FIG. 6(a) in translucency-opacity effect. Further, such inaccessible parts can be moved and swayed from its original position, and zoomed to view detailed 3D structure of the inaccessible part, here engine part 610 in an example as shown in FIG. 6(b).

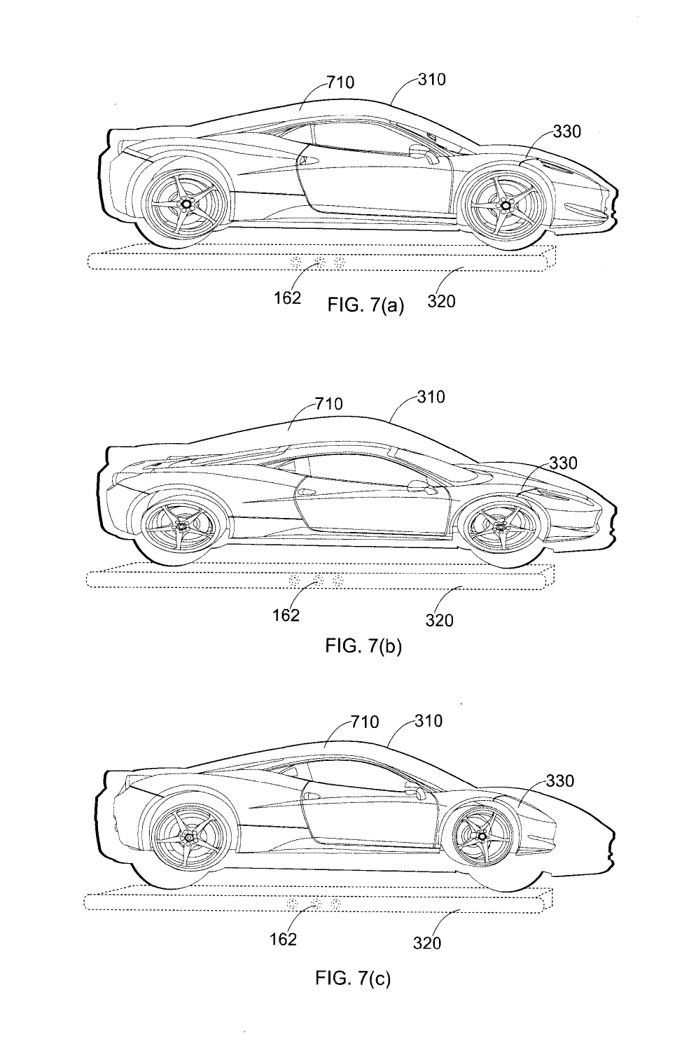

FIGS. 7(a)-(b) illustrates an example interaction of vertical and horizontal tilt with displayed object. In FIGS. 7(a)-(b), a gap 710 may be present or configured to reflect a gap between the outer boundary of the displayed object, that is the virtual model 330 representing a real car, and the boundary of the cut-to-shape display screen 310 during the alignment. The gap 710 allows vertical tilt and horizontal tilt interactions with the displayed virtual model 330 on the cut-to-shape display screen. The vertical tilt provides an additional view of top side as shown in FIG. 7(b). The horizontal tilt interaction by user provides an additional side view of the displayed virtual model 330 as shown in FIG. 7(c).

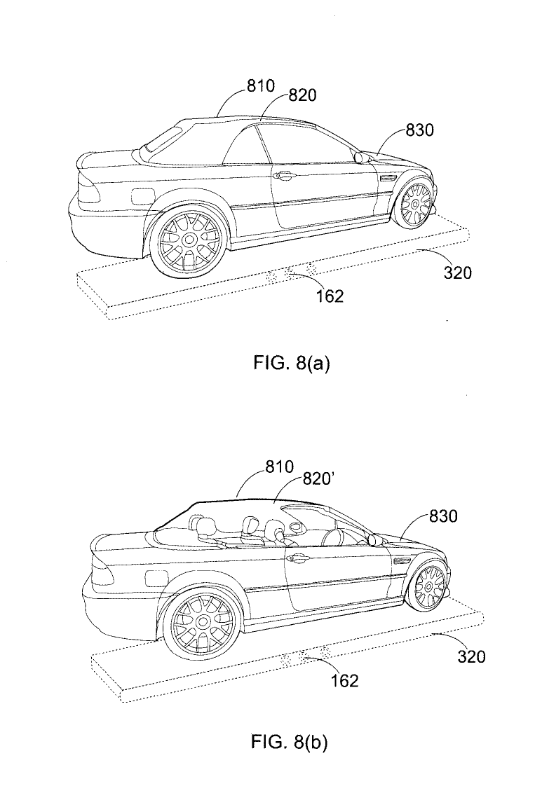

FIGS. 8(a)-(b) illustrates motion interaction as an example of operating movable external parts, where a roof part 820 of a virtual model 830 of a car displayed on a cut-to-shape display screen 810 folds when a user provides an interaction command for operating movable roof part in a folding motion interaction. As a result of the provided command, a real-time rendering of the folding motion takes place and the rendered view of virtual model 830 with folded roof 820′ is displayed in the display environment to the user in real-time in a realistic view.

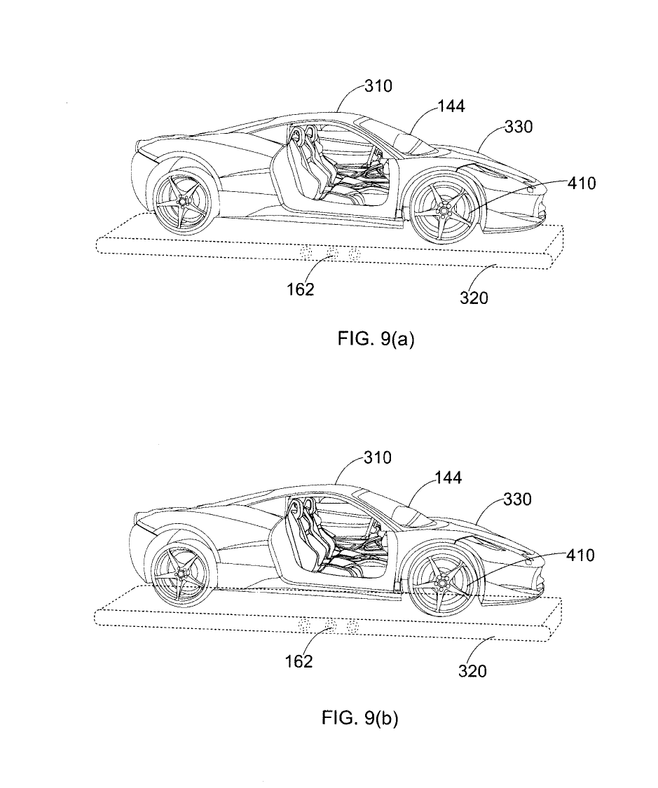

FIGS. 9 (a)-(b) illustrates an example interaction of replacing parts of displayed object with corresponding new parts having different texture. When a user provides an input on the touch pad to replace the seat part 430 from options provided on the GUI, a corresponding interactive view displaying the virtual model 330 is displayed quickly with replaced seat part having different texture 430′. Another example can be replacing seat covers to another color or design.

Optionally, the displayed object in an user-controlled interaction can be pushed back, and the gap created between outer edges of the displayed object and boundary of cut-to-shape display screen can be filled by a filler. The filler can be color filler, grid lines to create a 3D perception or 3D scene, text or icon display, or a merged view of near environment captured by a camera and displayed together with the displayed object to create illusion of merging with real background or near environment.

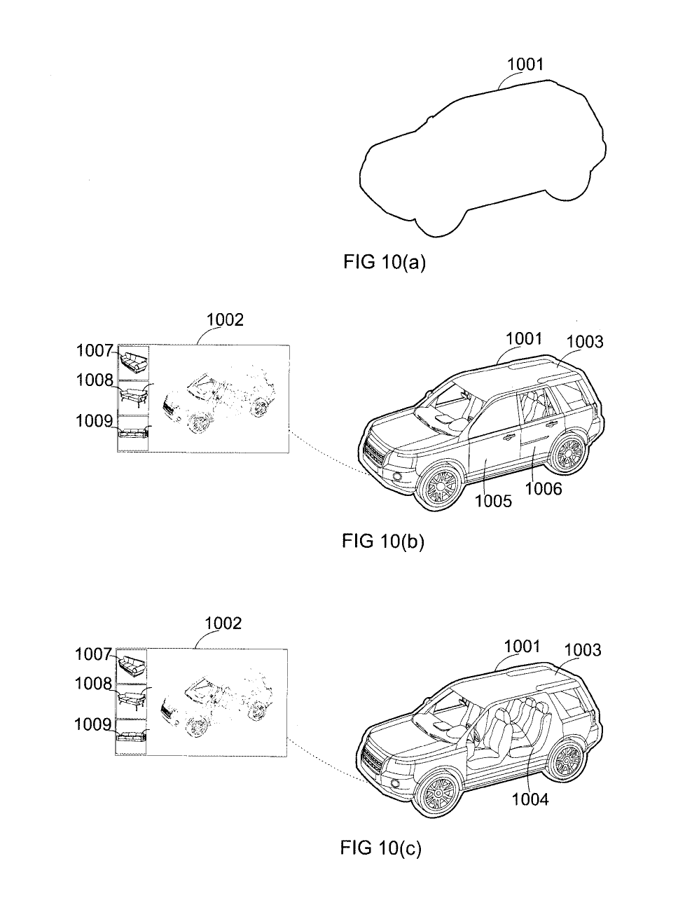

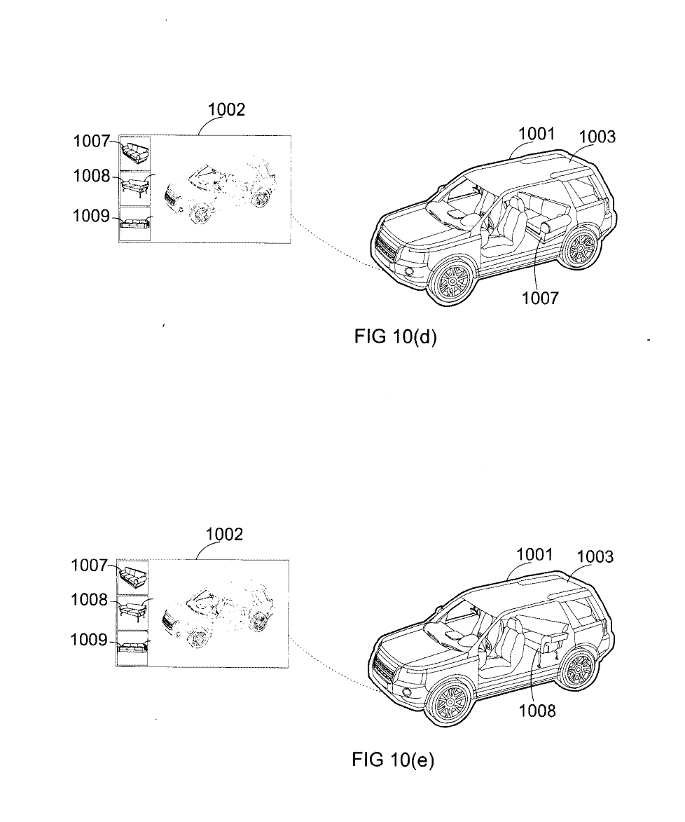

In FIG. 10(a), a cut-to-shape screen 1001 is shown in a shape of a car. In FIG. 10(b) to FIG. 10(e), a display 1002 of graphical user interface base input device is shown along with the cut-to-shape screen 1001 displaying virtual model 1003 of a car. In FIG. 10(b), a first view 1010 is shown for virtual model 1003 of the car on cut-to-shape screen 1001. The display 1002 is showing the car and various options 1007, 1008, 1009 for replacing or customizing back seat 1004 of the car. When user modifies the back seat of the virtual model 1003 of the car, to give an un-interrupted view of the back seat 1004 of the model, the gates 1005, 1006 of the virtual model 1004 of the car are removed, as in FIG. 10(c). As shown in FIG. 10(d), when user selects option 1007, the back seat 1004 of the virtual model is replaced by a sofa provided in option 1007. As shown in FIG. 10(e), when user selects option 1007, the back seat 1004 of the virtual model 1003 is replaced by a sofa provided in option 1008.

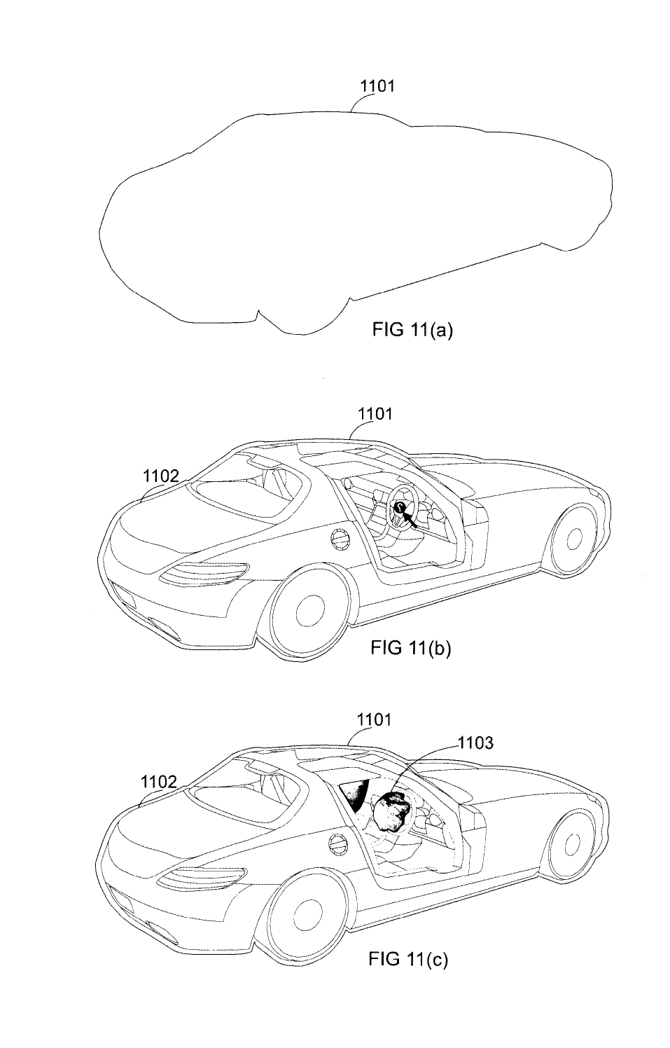

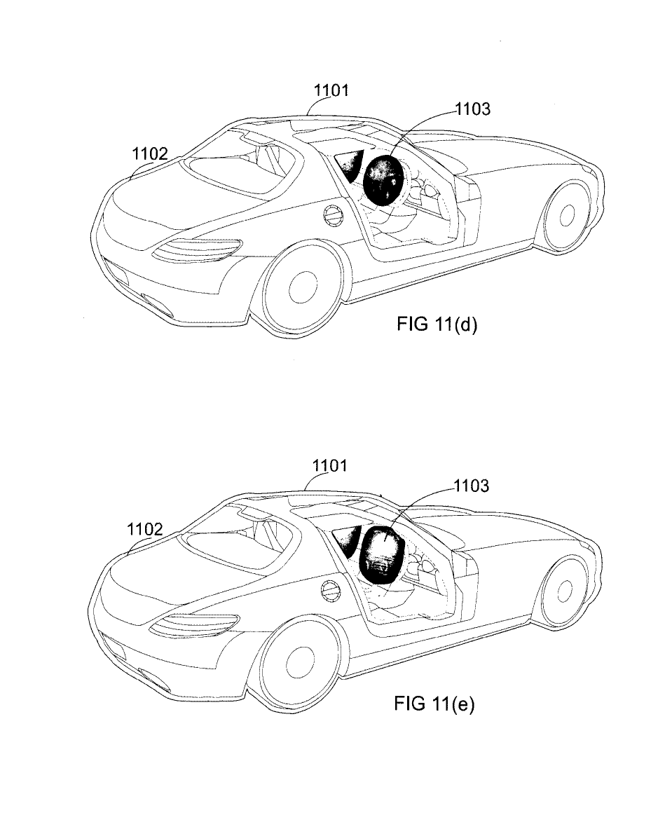

In FIG. 11(a), a cut-to-shape screen 1101 is shown in a shape of a car. When user inputs for interaction commands to demonstrate for inflation of an airbag 1103 of the virtual model 1102 of the car being shown on the cut-to-shape screen 1101, various stages of inflating the airbag 1103 is shown from FIG. 11(b) to FIG. 11(e). The process of inflating the airbag 1103 is automatic without further interaction commands from the user. However, while the airbag 1103 is inflating, the user can interact with other part/s of the virtual model 1102 by sending interaction commands for interacting in a particular way with that specific part/s.

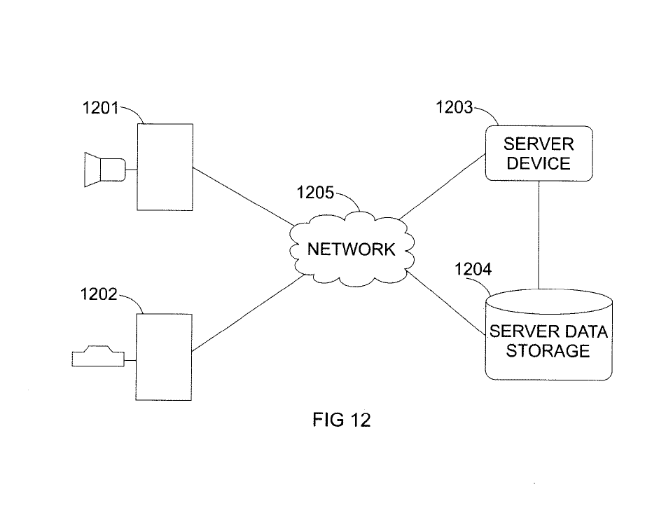

FIG. 12 is a simplified block diagram of a communication system, in which various embodiments described herein can be employed. Communication system includes client devices 1201 and 1202, which represent a computer connected with projector, a computer with cut to shape display. Each of these client devices may be able to communicate with other devices (including with each other) via a network 1205.

Few client devices can display the object on projector or cut to shape screen, while others can display virtual assistant on projector or cut to shape screen.

Client device can take input from a keyboard, a keypad, a touch screen, a computer mouse, a track ball, a joystick, and/or other similar devices, a simulator or a menu displayed on wearable computing devices, such as head-mounted displays and/or augmented reality display.

Network 1205 may be, for example, the Internet, or some other form of public or private Internet Protocol (IP) network. Thus, client devices 1201 and 1202 may communicate using packet-switching technologies. Nonetheless, network may also incorporate at least some circuit-switching technologies, and client devices 1201 and 1202 may communicate via circuit switching alternatively or in addition to packet switching.

A server device 1203 may also communicate via network 1205. In particular, server device 1203 may communicate with client devices 1201 and 1202 according to one or more network protocols and/or application-level protocols to facilitate the use of network-based or cloud-based computing on these client devices. Server device 1203 may include integrated data storage (e.g., memory, disk drives, etc.) and may be able to access separate server data storage 1204. Communication between server device 1203 and server data storage 1204 may be direct, via network, or both direct and via network as illustrated Server data storage 1204 may store application data that is used to facilitate the operations of applications performed by client devices 1201, 1202 and server device 1203.

Although only two client devices, one server device, and one server data storage are shown in FIG. 12, communication system may include any number of each of these components. For instance, communication system as shown in FIG. 12, may comprise any number of client devices, multiple server devices and server data storages. Furthermore, client devices may take on forms other than those in FIG. 12.

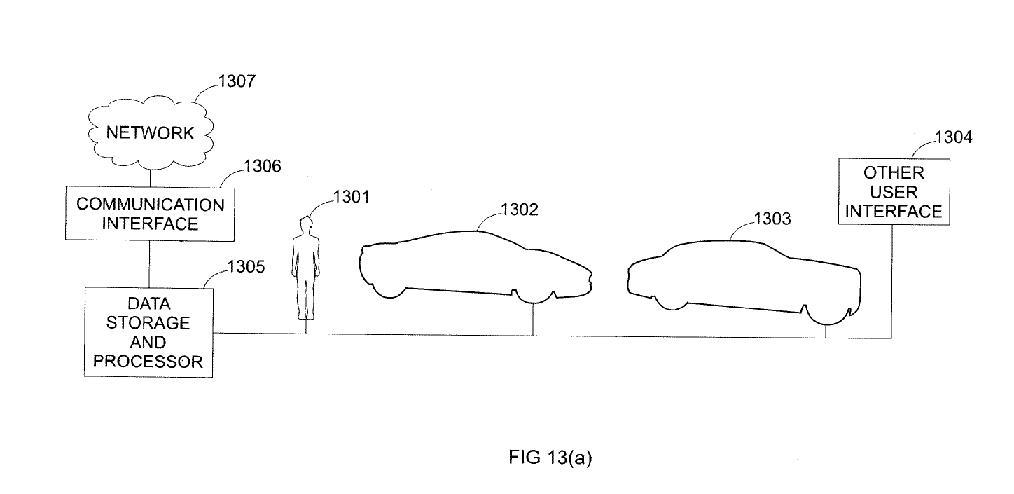

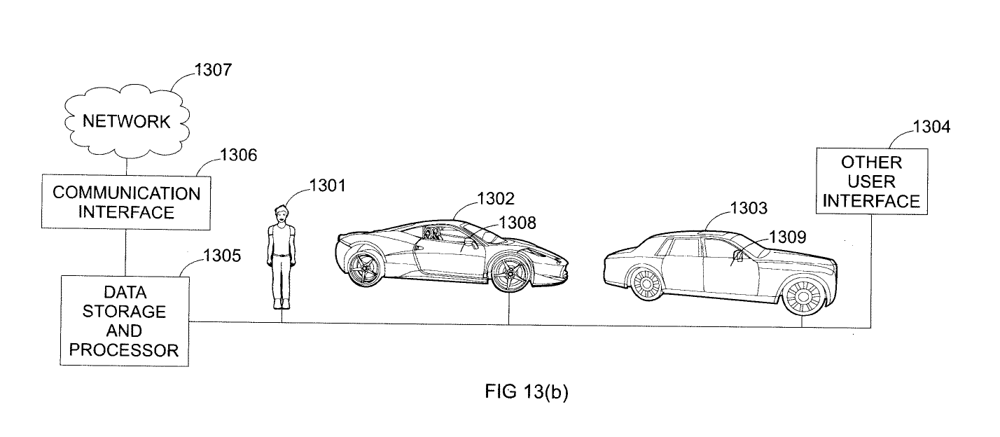

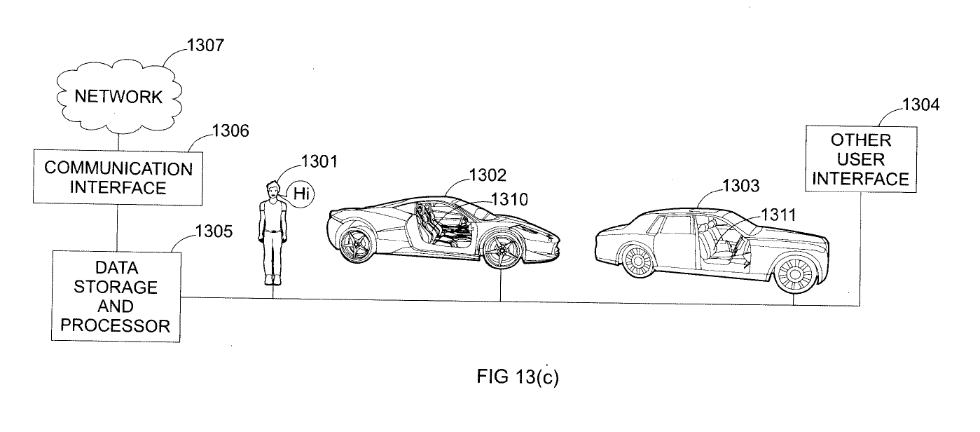

FIGS. 13(a)-(c) illustrates an exemplary system for visualizing at least one virtual model onto a cut-to-shape screen. In FIG. 13(a), the system includes four user interfaces, i.e., three cut-to-shape screens 1301, 1302, 1303 and one other user interface 1304, which can be input devices, output, displays and audio output. The user interfaces 1301, 1302, 1303, and 1304 are further connected to a computing device 1305, a communication interface 1306 and a network 1307. The cut-to-shape screens 1302 and 1303 are in shape of two different cars, while the cut-to-shape screen 1301 is in shape of a human representing a virtual assistant. In FIG. 13(b), a first view of virtual models of cars are displayed onto the cut-to-shape screens 1302, 1303. The user further interacts with the virtual model of cars for visualizing seats of the cars. In FIG. 13(c), for visualizing seats 1310, 1311 of the cars, the doors 1308, 1309 that were shown in FIG. 13(b) are removed. A user using the other user interface 1304 can send the interaction commands. While, the doors are being removed, the virtual assistant communicates in coordination with removing of the doors of the cars. This communication can be for explaining features of the cars and making comparison between the cars.

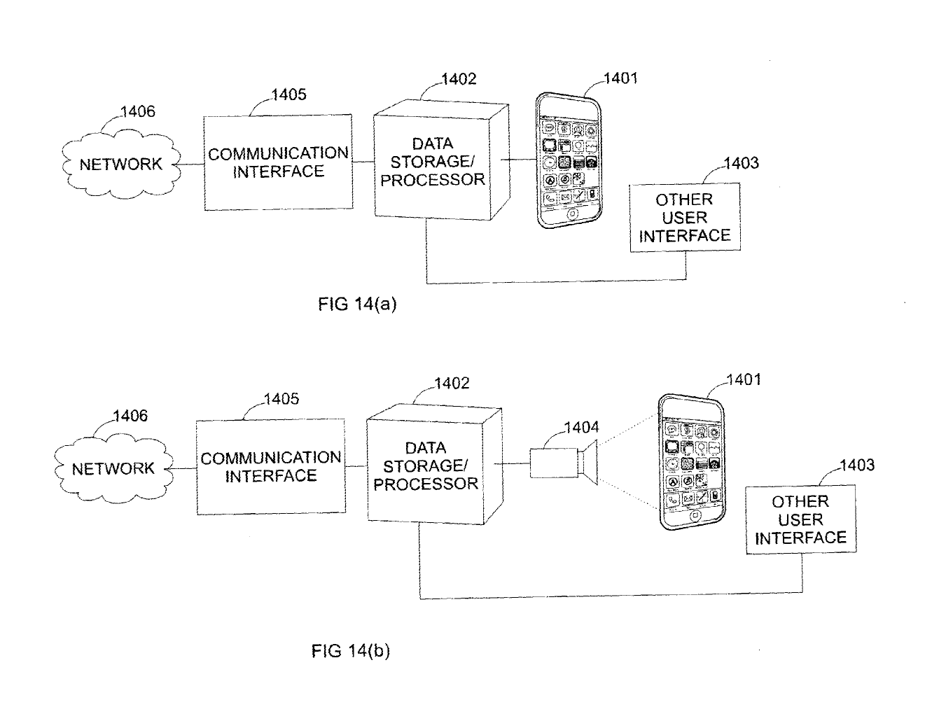

FIGS. 14(a)-(b) illustrates block diagrams of embodiments having two different types of cut-to-shape screens.

FIG. 14(a) illustrates a self-illuminating cut-to-shape screen 1401 connected to a computing device 1402, a communication interface 1405, a network 1406 and an user interface 1403 for visualizing interactive virtual model onto the cut-to-shape screen. The interaction commands are inputted through the input device 1403, which are further processed by the computing device 1402 to display the interactive virtual model after interaction onto the cut-to-shape screen 1401.

FIG. 14(b) illustrates the cut-to-shape screen 1401 being illuminated by a projector 1404. The projector 1404 is connected to a computing device 1402, a communication interface 1405, a network 1406 and a user interface 1403. The interaction commands are inputted through the input device 1403, which are further processed by the computing device 1402 and sent to the projector 1404, wherefrom the projector 1404 illuminates the virtual model onto the cut-to-shape screen 1401.

The user interface in FIGS. 13(a)-(c) and 14(a)-(b) is already defined in current disclosure and includes input devices, output, displays and audio output.

The same cut-to-shape display screen (210, 310, 810, 1001, and 1101) can be practically used to display an objects and variants of the displayed objects such as car model versions with same or near same dimension, where the outer boundary of the object's variants is same or almost same to be accommodated in the cut-to-shape display screen by the display environment. In one embodiment, instead of displaying entire virtual model on the cut-to-shape display screen (210, 310, 810, 1001, 1101), some portion such as the wheel part 410 can be covered by real wheel and the like.

1. A computer implemented method for visualization of a virtual model of an object over a cut-to-shape screen, wherein the screen dimensionally represents the virtual model of the object, such that an outer boundary of the virtual model either exactly aligned or nearly aligned to a boundary of the cut-to-shape screen, the method comprising:
rendering and displaying a first view of the virtual model onto the cut-to-shape screen, such that the outer boundary of the three dimensional model either exactly aligned or nearly aligned to the boundary of the cut-to-shape screen;
receiving an user input, the user input are one or more interaction commands, where each interaction command is provided for performing user-controlled interactions in real-time, wherein the interaction command is defined as input commands for performing different operations on different part/s of the virtual model to observe the virtual model and/or to experience functionality of virtual model and its part/s;
identifying one or more interaction commands;
in response to the identification, generating of corresponding interactive view of virtual model of object using texture data and computer graphics data of the virtual model of object;
displaying the generated corresponding interactive view of the virtual model either directly or via projector/s onto the cut-to-shape screen in response to the identification.

2. The method according to claim 1, wherein the cut-to-shape screen is either a screen illuminated by a projector receiving the interactive view by projecting the interactive view on the cut-to-shape screen or a self-illuminating screen receiving the interactive view and displaying the interactive view by illuminating itself.

3. The method according to the claim 1, wherein the cut-to-shape screen is having a degree of transparency from complete transparency to complete opacity.

4. The method according to the claim 1, wherein the virtual model is either two dimensional or three dimensional, and the computer graphics data is two dimensional computer graphics data of the object or three dimensional computer graphics data of the object.

5. The method according to claim 1, wherein the interactions comprises at least one of:
extrusive interactions for interacting with exteriors of the virtual model of the object, the intrusive interactions for interacting with internal parts and/or sub-parts of the virtual model, wherein sub-parts are those arts of the 3D-model which are moved and/or slided and/or rotated and/or operated for using the object, and the internal parts of the virtual model represent parts of the object which are responsible for working of object but not required to be interacted for using the object, wherein interacting with internal parts comprising removing and/or disintegrating and/or operating and/or rotating of the internal parts,
real environment mapping based interaction, which comprises capturing an area in vicinity of the user, mapping and simulating the video/image of area of vicinity on a surface of the virtual model,
addition based interaction for attaching or adding a part to the virtual model, and/or deletion based interaction for removing a part of virtual model, or
interactions for replacing the part of the virtual model with another part with same or different texture and/or shape and/or size by changing texture as well as graphics data of the part, such that that the outer boundary of the virtual model after customization is either exactly aligned or nearly aligned to the boundary of the cut-to-shape screen, wherein the replaced part is adapted to be interacted,
linked-part based interaction, such that when an interaction command is received for operating one part of virtual model, than in response another part linked to the operating part is shown operating in the virtual model along with the part for which the interaction command was received,
or combination thereof,
Wherein the extrusive interaction further comprises at least one of:
interacting with the virtual model for showing response of appropriate interaction in terms of change in graphics on the virtual electronic display and/or performing suitable operation in synchronization with part/s of the virtual model, if the object comprises an electronic screen and correspondingly the virtual model comprises a virtual electronic display,
interacting with virtual model of object for tilting the virtual model of the object in different planes, such that that the outer boundary of the virtual model either exactly aligned or nearly aligned to the boundary of the cut-to-shape screen, operating the light-emitting parts of virtual model of object for functioning of the light emitting parts, wherein functioning of light emitting part is shown by a video as texture on surface of said light emitting part to represent lighting as dynamic texture change,
interacting with virtual model for producing sound effects,
interactions for color change of the virtual model of the displayed object interactions for operating and/or removing the movable parts of the virtual model of the object, wherein operating the movable parts comprises sliding, turning, angularly moving, opening, closing, folding, and inflating-deflating the parts,
or combination thereof,
Wherein the intrusive interactions comprises at least one of:
interactions for receiving an un-interrupted view of the interior of the virtual model of the object and/or the sub-parts,
engineering disintegration interaction with part of the virtual model for visualizing the part within boundary of the cut-to-screen, the part is available for visualization only by dismantling the part from the entire object,
creating transparency-opacity effect for convening the internal part to be viewed as opaque and remaining virtual model as transparent or nearly transparent, time bound change based interactions, such that the time bound change is shown by dynamic change in the color and/or texture of surface of the virtual model, wherein different color and/or texture refers to different values of the physical property, and wherein the time bound changes refers to representation of changes in the virtual model demonstrating change in physical property of object in a span of time on using or operating of the object,
physical property based interactions to a surface of the virtual model, such that response to physical property based interactions are shown by change in color and/or texture of the surface of the virtual model, wherein different color and/or texture refers to different values of the physical property, and wherein physical property based interactions are made to asses a physical property of the surface of the virtual model, wherein the physical property comprises softness, hardness, pressure and temperature,
or combination thereof.

6-22. (canceled)

23. The method according to the claim 1, wherein the interaction comprises demonstration based interactions for requesting demonstration of operation of the part/s of the object which are operated in an ordered manner to perform a particular operation, response to such interaction includes automatic ordered operation of demonstrating part/s, whereas other part/s of virtual object are available for user controlled interactions while such operation is being performed.

24. (canceled)

25. The method according to the claim 1, wherein the interaction comprises liquid and fumes flow based interaction for visualizing liquid and fumes flow in the virtual model with real-like texture in real-time.

26. The method according to the claim 1, wherein the interaction comprises immersive interactions, the immersive interactions are defined as interactions where users visualize their own body performing user-controlled interactions with the virtual computer model.

27. The method according to the claim 1, wherein the displayed virtual model of the object is a computer graphics model textured using real photographs and/or video.

28. The method according to the claim 1, wherein the displayed virtual model of object is a computer graphics model textured using colour texture, images, preferably photographs and/or video, or their combination.

29. The method according to the claim 1, wherein displayed external and/or internal surfaces of the virtual model in-or-during each interactions are textured using photographs and/or video, where the display of texture on the virtual model surfaces using photographs ranges from 10-100% of total surfaces, which corresponds to non-mono-colour surface and surfaces which show pattern or non-uniform texture on the real object.

30. The method according to the claim 1, wherein if the displayed virtual model comprises a surface, which corresponds to functioning part in the real object, then a video is usable as texture on said surface of the virtual model during interaction to represent dynamic texture change on said surface.

31. The method according to the claim 1, wherein if the displayed 3D model comprises a surface which corresponds to light-emitting part in the real object, then a video is used as texture on said light-emitting part surface of the 3D model to represent lighting as dynamic texture change.

32. A computer program product stored on a computer readable medium and adapted to be executed on one or more processors, wherein the computer readable medium and the one or more processors are adapted to be coupled to a communication network interface, the computer program product on execution to enable the one or more processors to perform the method according to the claim 1.

33. A system for visualization of a virtual model of an object over a cut-to-shape screen, the system comprising:
the cut-to-shape screen which is self illuminating or illuminated through projector/s dimensionally represents the virtual model of the object, such that an outer boundary of the virtual model either exactly aligned or nearly aligned to a boundary of the cut-to-shape screen;
a computer graphics data related to graphics of the virtual model of the object, a texture data related to texture of the virtual model, and/or an audio data related to audio production by the virtual model, and/or an animation data related to animations of the virtual model, which is stored in one or more memory units;
and machine-readable instructions that upon execution by one or more processors cause the system to carry out operations comprising:
rendering and displaying a first view of the virtual model onto the cut-to-shape screen, such that the outer boundary of the three dimensional model either exactly aligned or nearly aligned to the boundary of the cut-to-shape screen;
receiving an user input, the user input are one or more interaction commands, where each interaction command is provided for performing user-controlled interactions in real-time, wherein the interaction command is defined as input commands for performing different operations on different part/s of the virtual model to observe the virtual model and/or to experience functionality of virtual model and its part/s;
identifying one or more interaction commands;
in response to the identification, generating of corresponding interactive view of virtual model of object using texture data and computer graphics data of the virtual model of object;
displaying the generated corresponding interactive view of the virtual model either directly or via projector/s onto the cut-to-shape screen in response to the identification.

34. The system according to the claim 33, wherein at least one of the processors and/or at least one of the memory units are remotely placed and connected to the other processors and other memory units over a communication network.

35. The system according to the claim 33 further comprising one or more sound output devices for providing synchronized sound output during display of the interactive view of the virtual model.

36. The system according to the claim 33, wherein the input device comprises at least one of a touch screen, a sensor unit configured for receiving gesture input commands for performing user-controlled interactions, a touch sensitive electronic display, a voice input device, a pointing device, a keyboard or presence-sensitive panel, computer mouse, joystick, microphone, still camera and/or video camera, tactile based input device or combination thereof.

37. The system according to the claim 33, wherein the memory unit/s further comprises a set of system libraries used by the processor for generating response to the interaction command, the system libraries comprises functionalities for at least one of:
producing sound as per user-controlled interaction;
animation of one or more parts in the virtual model;
providing functionality of operation of electronic or digital parts in the displayed virtual model/s depending on the characteristics, state and nature of displayed object;
decision making and prioritizing user-controlled interactions response;
putting more than one virtual object/model in scene;
generating surrounding or terrain around the 3D model;
generating effect of dynamic lighting on the 3D model;
providing visual effects of colour shades;
generating real-time simulation effect; or
using one or more environmental condition data comprising temperature, moisture, time or geographical/location related information,
Combination thereof.

38. The system according to the claim 33 comprising multiple cut-to-shape screen, wherein the multiple cut-to-shape screens are displaying synchronized output in response of user input from at least one user input device, such that at least one of the cut-to-shape screen is adapted to display the virtual model.

39. The system according to the claim 38 comprises at least one display screen other than cut-to-shape screens, wherein the display screen is adapted to display video including a video of virtual assistant with/without synchronization of output shown on cut-to-shape screen.

40. The system according to the claim 39 comprises at least one cut-to-shape screen which shows a video of virtual assistant with/without synchronization of virtual model shown on other cut-to-shape screen.

41-42. (canceled)
